(19) United States
(12) Patent Application Publication
(10) Pub. No.: US 2021/0332529 A1
(43) Pub. Date: Oct. 28, 2021

(54) DYE-SUBLIMATION PRINTING

(71) Applicant: HEWLETT-PACKARD DEVELOPMENT COMPANY, L.P., Spring, TX (US)

(72) Inventors: Alex Veis, Netanya (IL); Antonio Hinojosa Trigo, Sant Cugat del Valles (ES); Raimon Castells De Monet, Sant Cugat del Valles (ES)

(21) Appl. No.: 16/499,897

(22) PCT Filed: Jun. 15, 2018
(86) PCT No.: PCT/US2018/037830

§ 371 Date: Oct. 1, 2019

(51) Int. Cl. D06P 5/20; B41M 5/382; B41M 5/035; D06P 5/28

(52) U.S. Cl. CPC D06P 5/2005; B41M 5/38242; D06P 5/004; B41M 5/38221; B41M 5/035

(57) ABSTRACT

Dye-sublimation printers and methods are disclosed for porous substrates or for polyester-coated substrates. In an example the device comprises a substrate path, a printhead, over a print zone of the substrate path, to transfer a print fluid on the substrate; a narrow band radiation source, over a sublimation zone of the substrate path to sublimate a portion of the transferred print fluid to form an image on the substrate; and an advancing mechanism, to transfer the substrate from the print zone to the sublimation zone.

### BACKGROUND

Dye sublimation (also known in the art as “dye-sub”) is a common way to print on substrates, e.g. polyester based substrates and polyester coated substrates. Some dye-sub methods involve printing an image, e.g. a digital design, to a transfer medium, e.g. paper, using sublimation dyes and then transferring the image from the transfer medium to a final substrate, e.g. to a polyester fabric or to a polymer-coated substrate fabric. After the image is printed onto sublimation transfer media, it is placed on a heat press along with the substrate to be sublimated. In order to transfer the image from the transfer medium to the substrate, a sublimator is used. The sublimator applies a process that is a combination of time and temperature using a heat press. The heat press applies this combination, which can change depending on the substrate, to “transfer” the sublimation dyes at the molecular level onto the substrate. The end result of the sublimation process is a nearly permanent, high resolution, full color print.

The sublimator, also called “fixation heater”, is a self-structure device. The substrate may pass through a set of rollers. One or more of them, also called “heat transfer rollers”, may be in contact with the substrate to heat it. These heat transfer rollers may have a flow of heat oil circulating inside them or an infrared lamp. In the case of using oil, an external heating device may be heating the oil and a pump may be used to flow the oil though the circuit.

### BRIEF DESCRIPTION OF THE DRAWINGS

Various example features will be apparent from the detailed description which follows, taken in conjunction with the accompanying drawings, wherein:

FIG. 1 schematically illustrates a side view of a dye-sublimation printer for a substrate, according to an example;

FIG. 2 schematically illustrates a top view of a dye-sublimation printer for a substrate, according to an example;

FIG. 3 schematically illustrates a substrate during a dye-sub printing process, according to an example;

FIG. 4 schematically illustrates a flow diagram of a method of direct printing an image on a substrate, according to an example.

### DETAILED DESCRIPTION

Sublimators using heat transfer rollers use energy that may employ a power source that has a power that is multiple times the power of the printer. For example, a printer may use less than 10 kVA of electrical power, whereas the sublimator device may use more than 20 kVA. Furthermore, in some sublimators the heating system may take more than 10 minutes to warm-up. This is to achieve a constant temperature on the surface of the heat rollers. Another characteristic of some sublimators is that the time exposure to sublimate through the rollers is relatively high (in the order of 30 sec). Therefore, the steady state speed is relatively low compared to the printing speed. Further to that, due to their complexity and volume, some sublimators are difficult to integrate in a printer.

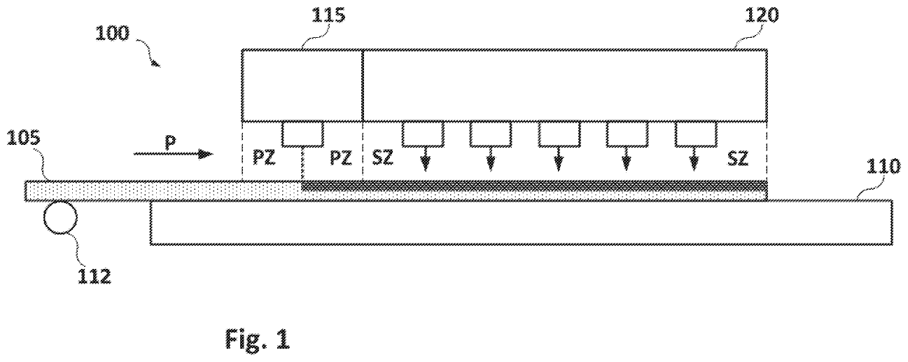

FIG. 1 schematically illustrates a side view of a dye-sublimation printer for a substrate, according to an example. The dye-sublimation printer 100 may comprise a substrate path 110. A substrate 105, e.g. a porous substrate or a polyester-coated substrate may be transferred over the substrate path 110. The printer 100 may comprise a printhead 115. A print zone (PZ) may be defined between the printhead 115 and a first portion of the substrate path 110. The printhead 115 may form part of a page-wide-array or may be relatively moveable over the print zone of the substrate path and may transfer a print fluid on the substrate to print an image on the substrate 105. In some examples, the substrate 105 may relatively move along a print direction (P) on the substrate path 110. The printer 100 may comprise a narrow band radiation source 120. A sublimation zone (SZ) may be defined between the narrow band radiation source 120 and second portion of the substrate path 110. An advancing mechanism 112 may transfer the substrate 105 on the substrate path 110 from the print zone to the sublimation zone. The narrow band radiation source 120 may form part of the page-wide array or may be relatively moveable over the sublimation zone of the substrate path 110 to sublimate a portion of the transferred print fluid to form an image on the substrate. In some examples, the printer may comprise a heating source (not shown), e.g. a drying or curing source, between the printhead 115 and the narrow band radiation source 120 along the substrate path.

In the present disclosure the substrate path should be understood as an area that is at least partially occupied by the substrate as the substrate moves along the dye-sublimation printer.

The narrow band radiation source may be a visible light (e.g. Red-Green-Blue (RGB) color) or an Ultraviolet (UV) (e.g. UV-A) radiation LED lamp, however it could be any narrow band radiation source selected to match with the absorption wavelength of the colorants or of the substrate. For example, the radiation source may comprise LED lamps that may emit radiation at a frequency band selected based on the absorption wavelength of the colorants or of the substrate. The LED lamps may be capable to generate radiation at a wide band spectrum. However, a narrow band may be selected from a look-up table based on the absorption wavelength of the colorants or of the substrate. The dye-sub fluid or ink and/or the substrate may react under such narrow band radiation and the pigmenting process may be performed. When a porous substrate is used, the colorants and/or the substrate may be heated due to resonance, and then the sublimation process may occur while the pores of the substrate may open. When a polyester-coated substrate is used, the heating may cause the sublimation process to occur and the pores of the polyester coating to open to encapsulate the colorant. Therefore, time exposure is minimized since the heating process is generated directly in the colorant and in the substrate instead of being transferred indirectly from a conductive process. Furthermore, the narrow band radiation source may be compact in size, so that it may be integrated in a printer. Also, in an example, no additional treatment fluids are applied to perform the sublimation.

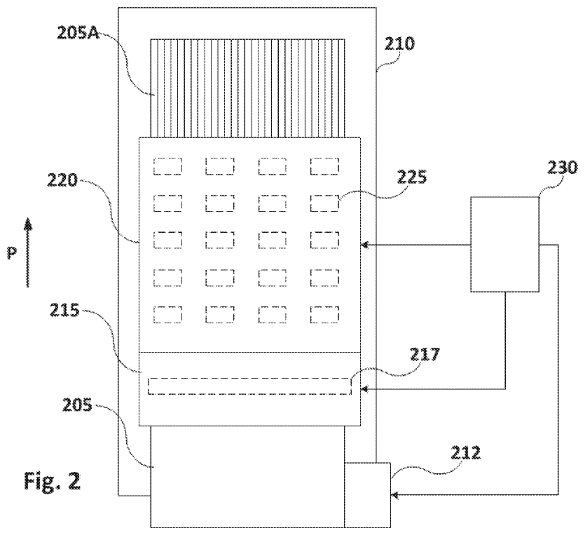

FIG. 2 schematically illustrates a top view of a dye-sublimation printer for a porous substrate, according to an example. A porous substrate 205 may be moveable along a substrate path 210 in a printing direction P. An advancing mechanism 212 may move the porous substrate 205 along the substrate path 210. A printing module 215, e.g., a page-wide array 215 with a printhead 217, may transfer printing fluid, e.g., dye-sublimation fluid on the porous substrate 105 to form an image on the substrate in a print zone below the printhead 217. The substrate may then move to a sublimation zone defined as the zone below a narrow band radiation source 220 covering part of the substrate path 210. The narrow band radiation source 220 may comprise narrow band radiation elements 225, e.g. Light Emitting Diode (LED) lamps 225. The LED lamps 225 may emit radiation in the visible or in the Ultraviolet (UV) spectrum. The LED lamps may form an array along and across the print direction P. The frequency of radiation of the narrow band radiation source 220 may be tuned in order to correspond with the absorption spectrum of the porous substrate or of the dye-sub inks. Both the porous substrate and the dye-sub fluids are to be heated. The dye-sub fluid is heated to be sublimated, i.e. transformed from solid to gas. Once in a gas state, the gas may penetrate the substrate and become part of it to pigment the substrate. The porous substrate (e.g. polyester based or coated) is heated to open its pores where the sublimated fluid is to be trapped.

Each of the narrow band radiation elements 225 may have a frequency tuned to an absorption wavelength of a color, e.g. cyan, magenta, yellow or black. For example, some radiation elements may be tuned to the cyan colour wavelength, some to the magenta color wavelength, some to the yellow colour wavelength and some to the black colour wavelength. Thus sublimation may take place in all the colors.

A controller 230 may be coupled to the advancing mechanism 212, to the printing module 215 and to the narrow band radiation source 220. The controller 230 may control the advancing speed, the printing speed and the sublimation power.

As the frequency of the narrow band radiation source may be tuned to the absorption wavelength of the substrate or of the colorant, the substrate, exposure time to sublimate may be reduced compared to the time for sublimation and energy efficiency may be increased. Also, the transient times of warm-up and cool-down of the radiation source, less than 5 seconds, may be much less compared to that of the heated rollers.

The size of the narrow band radiation source 220 and the number of radiation elements may depend on a ratio of the printing speed to the sublimation speed. For example, if the printing speed is double the sublimation speed, then a size of the sublimation zone along the print direction may be double the size of the printer. That way, a porous substrate or a polyester-coated substrate may be in the sublimation zone twice the time that it may be in the print zone. Thus, by knowing the ration of print speed to sublimation speed, size of the print and sublimation zones may be associated accordingly and the process may be integrated in a single pass and in a single device. Furthermore, having an array of narrow band radiation elements allows for better distribution of the radiation energy during the sublimation time. Each substrate may have a limit as to the radiant exposure it may absorb. However, a minimum energy may be employed to sublimate the inks. To perform sublimation without damaging the substrate, the radiant exposure may need to be limited and extended in time or in periods of time. This may be achieved with multiple narrow band radiation elements. For example, each narrow band radiation element may provide a portion of the substrate with a radiant energy to provoke sublimation of an ink but without damaging the substrate. However, due to the speed of processing, the portion of the substrate may move outside the range of the narrow band radiation element before sublimation of the ink in question is finished. Then, a next narrow band radiation element in line may continue with the sublimation process.

The printhead may be a page-wide array printer printhead or a scanning printer printhead mounted on a moveable carriage. The narrow band radiation source may be an LED (in the visible or UV spectrum) radiation source or a narrow band laser source, e.g. a CO2 laser type source may be used. No separate power source may be used and both the printhead and the narrow band radiation source may be integrated in a printer,

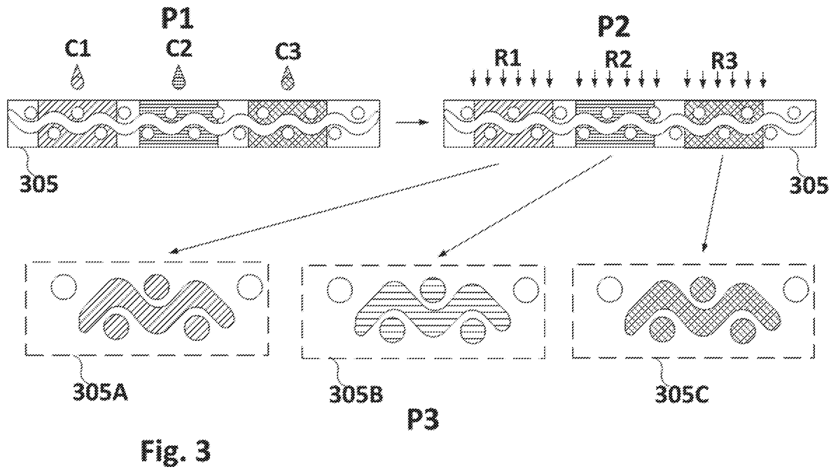

FIG. 3 schematically illustrates a porous substrate during a dye-sub printing process, according to an example. During a first phase P1, the porous substrate 305 may be printed with multiple dye-sub inks. For example, a first region 305A of substrate 305 may be printed with a first ink C1 having a first colour, a second region 305B of substrate 305 may be printed with a second ink C2 having a second colour and a third region 305C of substrate 305 may be printed with a third ink C3 having a third colour. The printed dye-sub inks may float on the porous substrate or on a coating of the porous substrates during phase A. Then in a second phase P2, the substrate 305 may be radiated with multiple radiation frequencies R1, R2 and R3. Each frequency may correspond to an absorption frequency of the inks C1, C2 and C3, respectively. In other examples, printing and radiating may be performed alternatively. In such cases, the first ink C1 may be printed and then radiation R1 may be applied, then the second ink C2 may be printed and the second radiation R2 may be applied, and so on. The radiation may cause the inks to heat up and to sublimate. Then, during a third phase P3, the liquid elements of the inks may have sublimated and the colorants may have impregnated the pores of the substrate and have pigmented the substrate.

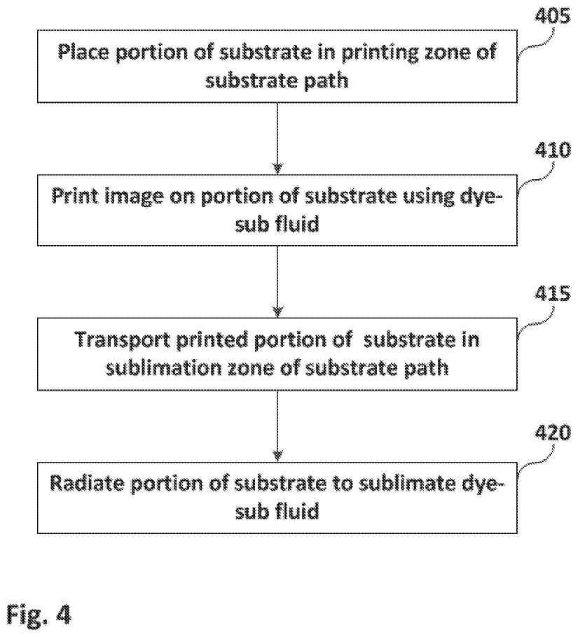

FIG. 4 schematically illustrates a flow diagram of a method of direct printing an image on a porous substrate or on a polyester-coated substrate, according to an example. In block 405, a portion of the substrate may be placed in a printing zone of a substrate path. In block 410, the image may be printed on the portion of the substrate using a dye-sublimation ink. In block 415, the printed portion of the substrate may be transported in a sublimation zone of the substrate path. In block 420, the printed portion of the substrate may be radiated to sublimate the print fluid using narrow band radiation. While the printed portion of the substrate is being sublimated, another portion of the substrate may be printed. Thus the process may be integrated in a single pass. The speed of printing and sublimating may be homogenized by extending the sublimation zone, with respect to the printing zone, according to the difference or the ratio between the printing speed and the sublimation speed.

The preceding description has been presented to illustrate and describe certain examples. Different sets of examples have been described; these may be applied individually or in combination; sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A dye-sublimation printer for a substrate, comprising:
a substrate path,
a printhead, over a print zone of the substrate path, to transfer a print fluid on the substrate;
a narrow band radiation source, over a sublimation zone of the substrate path to sublimate a portion of the transferred print fluid to form an image on the substrate; and
an advancing mechanism, to transfer the substrate from the print zone to the sublimation zone.

2. The dye-sublimation printer according to claim 1, the print fluid comprising a dye-sublimation ink.

3. The dye-sublimation printer according to claim 1, the printhead having a line printing speed and the narrow band radiation source having a sublimation speed,
wherein a size of the narrow band radiation source is selected based on a ratio of the printing speed to the sublimation speed.

4. The dye-sublimation printer according to claim 1, the narrow band radiation source comprising an LED narrow band radiation source emitting radiation in the visible or in the ultraviolet (UV) spectrum.

5. The dye-sublimation printer according to claim 1, the narrow band radiation source comprising LED lamps emitting radiation at a frequency band selected in view of an absorption wavelength of the print fluid or of the substrate.

6. The dye-sublimation printer according to claim 1, the narrow band radiation source comprising multiple LED lamps arranged in an array, wherein different lamps of the array are to emit radiation at different frequency bands, at least one of the bands selected to resonate with an absorption wavelength of a color print fluid.

7. The dye-sublimation printer according to claim 1, the narrow band radiation source comprising a laser source.

8. The dye-sublimation printer according to claim 1, the printhead being mounted on a moveable carriage

9. The dye-sublimation printer according to claim 1, the printhead comprising a page-wide array printhead or a moveable printhead.

10. The dye-sublimation printer according to claim 1, the substrate comprising a polyester substrate or a polyester coated substrate.

11. The dye-sublimation printer according to claim 1, comprising a heating source between the printhead and the narrow band radiation source along the substrate path.

12. Method of direct printing an image on a substrate, comprising:
placing a portion of the substrate in a printing zone of a substrate path;
printing the image on the portion of the substrate using a dye-sublimation print fluid;
transporting the printed portion of the substrate in a sublimation zone;
radiating the portion of the substrate to sublimate the print fluid using a narrow band frequency radiation.

13. Method according to claim 12, comprising drying the print fluid on the portion of the surface before the portion of the surface is transported to the sublimation zone.

14. Method according to claim 12, wherein radiating comprises tuning a radiation frequency according to an absorption spectrum of the substrate or of the print fluid.

15. A fabric printing-sublimation device, comprising:
a fabric conveyor;
a dye-sublimation ink source to print an image on a fabric in a print zone of the fabric conveyor;
a narrow band LED sublimator, to sublimate the dye-sublimation ink of the printed image in a sublimation zone of the fabric conveyor.
